(19) United States
(12) Patent Application Publication
(10) Pub. No.: US 2016/0334098 A1
(43) Pub. Date: Nov. 17, 2016

(54) HEATING CABINET

(71) Applicant: KARIS CO., LTD.

(72) Inventors: DUG WOO LEE, Gimpo-si (KR); SANG HYUN LIM, Gimpo-si (KR); JONG OH KIM, Bucheonsi (KR); CHUN SEOK SONG, Gimpo-si (KR); TAE MYOUNG KIM, Gimpo-si (KR)

(21) Appl. No.: 15/143,512

(22) Filed: Apr. 30, 2016

(30) Foreign Application Priority Data
May 15, 2015 (KR) 10-2015-0068039

(51) Int. Cl. F22B 1/28; H05B 3/00; F24H 1/00; H05B 1/02

(52) U.S. Cl. CPC F22B 1/28; H05B 1/0272; H05B 3/0014; F24H 1/0018

(57) ABSTRACT

Disclosed herein is a heating cabinet, in which a water collection tray is located in the heating cabinet such that the tray is not exposed to the outside, and water produced when an object is heated is collected in the water collection tray. The heating cabinet includes a main body defining a heating space in which an object to be heated is seated, a water collection tray provided under the heating space to be accommodated in the main body, and collecting water produced when the object is heated, and a front door rotatably coupled to a side of the main body to selectively close the open heating space while receiving the water collection tray, the front door having a guide part that is formed on a surface facing the heating space to guide the water, produced when the object is heated, to the water collection tray.

### BACKGROUND OF THE INVENTION

1. Field of the Invention

The present invention relates to a heating cabinet. More particularly, the present invention relates to a heating cabinet, in which a water collection tray for collecting water is located in the heating cabinet such that the tray is not exposed to the outside, water produced when an object is heated is collected in the water collection tray, and a top of the water collection tray is closed to prevent water collected therein from overflowing when the water collection tray is separated or moved from the heating cabinet.

2. Description of the Related Art

Generally, in order to use a steam towel that is always heated to a preset temperature in a barbershop/beauty salon, a nail shop, a skin care shop, a massage shop, a restaurant, a physical therapy department or the like, a heating cabinet having a heating device therein is employed.

Such a heating cabinet is used to heat an object (e.g., wet towel or beverage) seated therein to a preset temperature by the heating device and storing the object for a lengthy period of time. A heating space with a predetermined size is defined in the heating cabinet to heat the object. Shelves may be provided in multiple layers in the heating space to keep the object thereon.

When a user desires to store a steam towel in the heating cabinet, the heating device is driven to heat the wet towel seated in the heating space to a preset temperature, thus allowing the hot steam towel to be always available.

Korean Patent Application Publication No. 10-2012-0019820 discloses a heating cabinet for storing a steam towel. A tiltable door having a protruding rim is coupled to a front of a vertical door sill that is provided on a front entrance of the heating cabinet, thus allowing the door to easily come into close contact with a gasket of the entrance and then close the entrance. Here, a sill support covers an outer surface of a reinforcing member provided on the front of the door sill to protrude forwards. A water discharge means is provided on a lower portion of an inner surface of the door to discharge steam pressure in a heating chamber and water flowing down along the inner surface of the door.

However, the heating cabinet for storing the steam towel is problematic in that a water collection container is provided on a lower surface of the heating cabinet to collect water that is dropped through a water outlet hole, so that water may overflow when the water collection container is separated from the heating cabinet.

That is, since a top of the water collection container is open, it is difficult to control water sloshing in the water collection container when it is separated from the heating cabinet.

Moreover, when a user holds and moves the separated water collection container, water may undesirably overflow and thus contaminate surroundings of the water collection container.

Further, as a steam release hole, a small drain, a vertical space, and a water outlet hole for discharging water are formed to communicate with each other, an interior and an exterior of the heating cabinet communicate with each other, thus affecting the creation of the internal pressure of the heating cabinet.

In other words, the reason is because a water discharge structure of the heating cabinet is made to discharge water to the external water collection container.

### RELATED ART DOCUMENT

### Patent Document

(Patent 1) Korean Patent Application Publication No. 10-2012-0019820 (published on Mar. 7, 2012)

(Patent 2) Korean U.M. Registration No. 20-0444624 (registered on May 19, 2009)

### SUMMARY OF THE INVENTION

Accordingly, the present invention has been made keeping in mind the above problems occurring in the related art, and an object of the present invention is to provide a heating cabinet, in which a water collection tray for collecting water is located in the heating cabinet such that the tray is not exposed to the outside, water produced when an object is heated is collected in the water collection tray, and a top of the water collection tray is closed to prevent water collected therein from overflowing when the water collection tray is separated or moved from the heating cabinet.

In order to accomplish the above object, the present invention provides a heating cabinet including a main body defining a heating space in which an object to be heated is seated; a water collection tray provided under the heating space to be accommodated in the main body, and collecting water produced when the object is heated; and a front door rotatably coupled to a side of the main body to selectively close the open heating space while receiving the water collection tray, the front door having a guide part that is formed on a surface facing the heating space to guide the water, produced when the object is heated, to the water collection tray.

The water collection tray may be inserted into the main body such that part of the water collection tray is exposed from the main body, an accommodation recess with a predetermined depth may be defined in the main body to allow the water collection tray to be accommodated in the main body, and a receiving recess may be defined in a surface of the front door corresponding to the accommodation recess to receive the part of the water collection tray that may be exposed from the main body.

The water collection tray may include a water collection container having a predetermined length, with a space defined to collect water therein; a top cover closing an open top of the water collection container; and a water inlet hole formed through the top cover at a center in a longitudinal direction of the top cover that is exposed from the main body, water guided through the guide part of the front door being introduced into the water inlet hole.

Here, the water inlet hole may be formed at a center in a longitudinal direction of an inclined groove such that the water inlet hole may be formed under a surface of the top cover, the inclined groove being formed in part of the top cover that may be exposed from the main body to be depressed and being gradually inclined downwards from each of opposite sides in the longitudinal direction of the top cover to a center thereof.

Further, the guide part of the front door may include a depressed surface formed on the surface facing the heating space to be depressed at a predetermined depth; an inclined edge formed at a predetermined angle from each of opposite ends of a lower portion of the depressed surface to the water collection tray such that the water produced in the depressed surface when the object is heated in a state where the front door closes the heating space is guided into the water collection tray; and a water collection path formed at an end of the inclined edge and connected with the depressed surface such that guided water flows towards the water collection tray.

As is apparent from the above description, the present invention provides a heating cabinet, in which a water collection tray for collecting water is located in the heating cabinet such that the tray is not exposed to the outside, thus improving a front structure of the heating cabinet, and water produced when an object is heated is collected in the water collection tray, thus keeping an interior of the heating cabinet closed, and a top of the water collection tray is closed, thus preventing water collected therein from overflowing when the water collection tray is separated or moved from the heating cabinet.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a heating cabinet according to the present invention;

FIG. 2 is a perspective view illustrating the heating cabinet, in which a front door of the heating cabinet is open;

FIG. 3 is a sectional view illustrating essential parts of FIG. 1;

FIG. 4 is an exploded perspective view illustrating a water collection tray included in the heating cabinet according to the present invention; and

FIG. 5 is a perspective view illustrating the heating cabinet, in which the water collection tray is separated from the heating cabinet.

### DESCRIPTION OF PREFERRED EMBODIMENTS

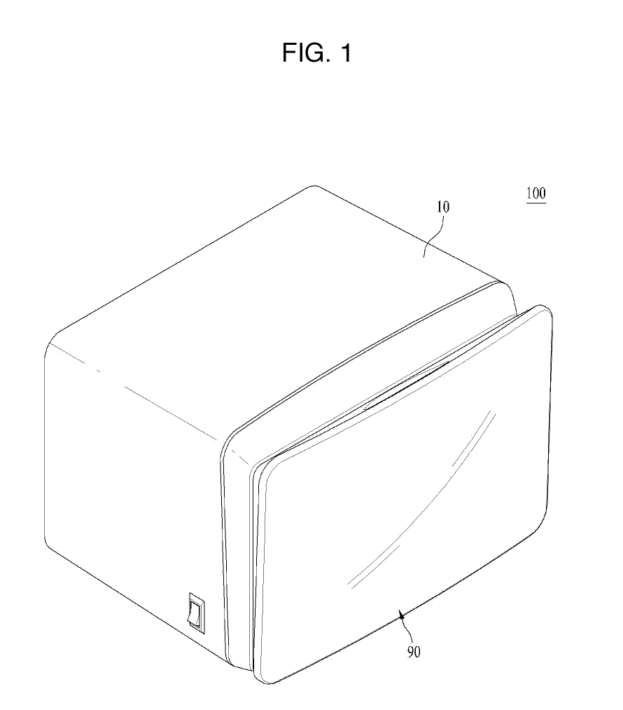

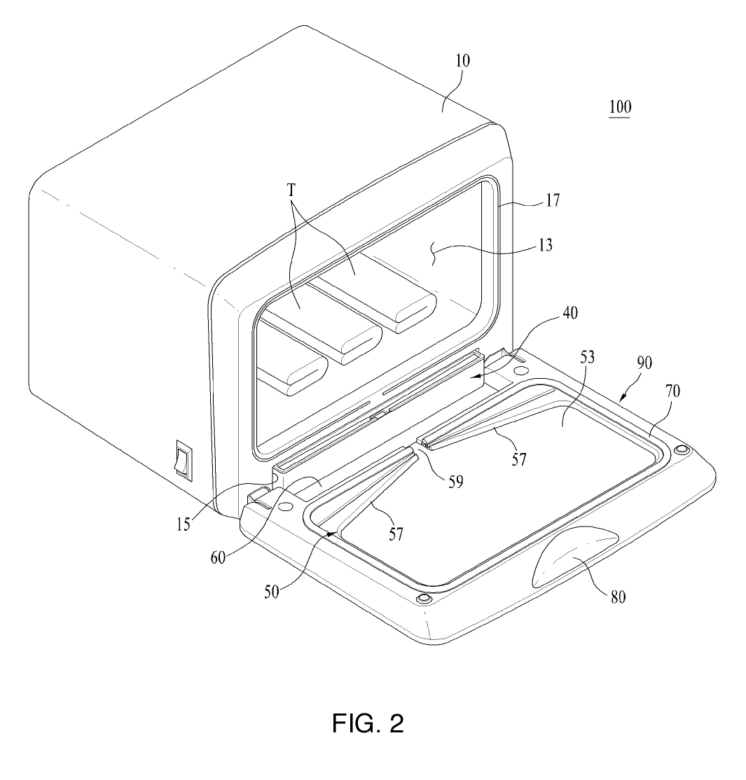

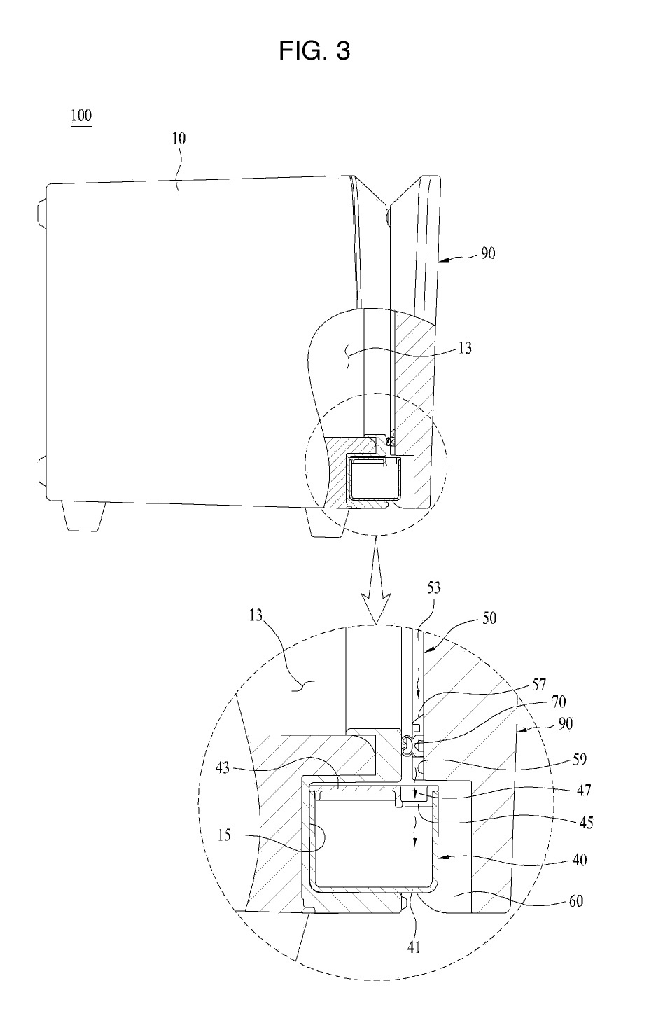

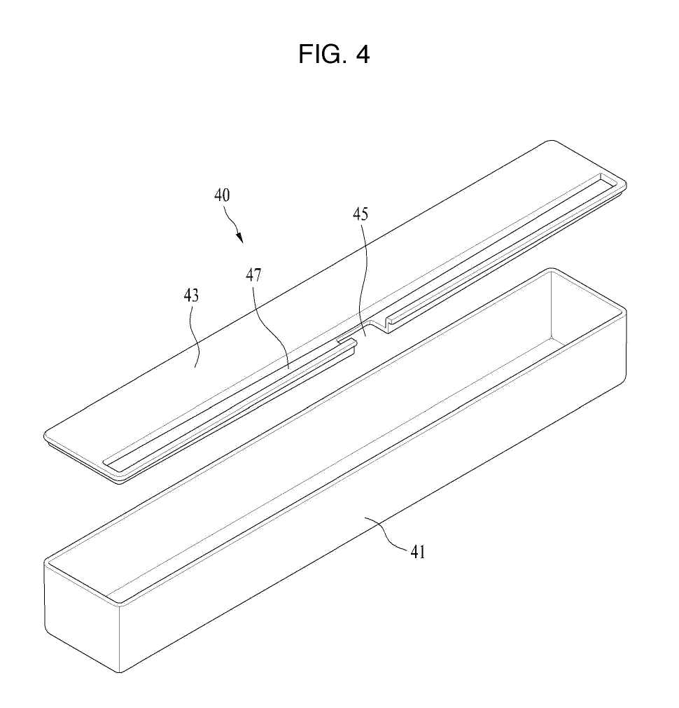

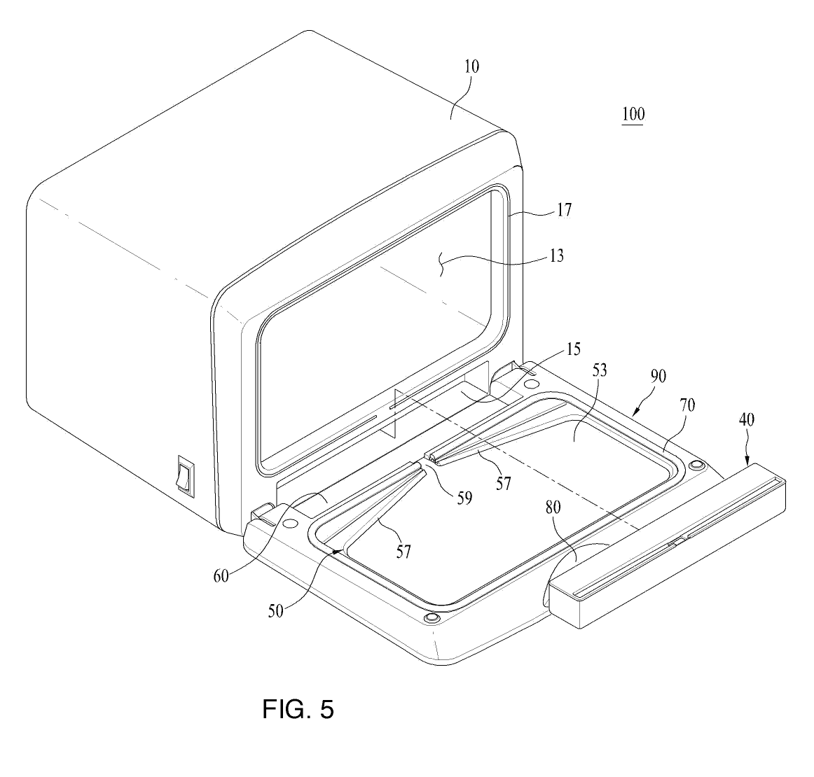

FIG. 1 is a perspective view illustrating a heating cabinet according to the present invention; FIG. 2 is a perspective view illustrating the heating cabinet, in which a front door of the heating cabinet is open; FIG. 3 is a sectional view illustrating essential parts of FIG. 1; FIG. 4 is an exploded perspective view illustrating a water collection tray included in the heating cabinet according to the present invention; and FIG. 5 is a perspective view illustrating the heating cabinet, in which the water collection tray is separated from the heating cabinet.

As shown in FIGS. 1 to 5, a heating cabinet 100 according to the present invention includes a main body 10 defining a heating space 13 in which an object T to be heated is seated, a water collection tray 40 provided under the heating space 13 to be accommodated in the main body 10 and collecting water produced when the object T is heated, and a front door 90 rotatably coupled to a side of the main body 10 to selectively close the open heating space 13 while receiving the water collection tray 40, the front door having a guide part 50 that is formed on a surface facing the heating space 13 to guide the water, produced when the object T is heated, to the water collection tray 40.

The heating cabinet will be described below with reference to FIGS. 1 to 5.

The heating cabinet 100 of the present invention mainly includes the main body 10, the water collection tray 40, and the front door 90.

The main body 10 has an approximately rectangular shape, and defines the heating space 13 having a predetermined depth and space to allow the object T (towel or beverage) to be seated therein.

A plurality of shelves (not shown) may be provided in the heating space 13 to allow the object T (hereinafter referred to as a ‘towel T’) to be seated thereon in multiple layers.

Meanwhile, a heating device (not shown) is provided between the main body 10 and the heating space 13, and the heating space 13 is heated to a preset temperature by driving the heating device. Of course, the heating device is driven by the supply of electric power.

As shown in FIGS. 2 and 3, the water collection tray 40 is installed in the main body 10 to be accommodated through a lower portion of the main body 10, namely, a lower portion of the main body defining the heating space 13, and collects water produced when the object T is heated.

Specifically, the water collection tray 40 is installed to be accommodated in the main body 10 like a drawer, and collects water produced when the wet towel T seated in the heating space 13 is heated in the state where the water collection tray is inserted into the main body 10.

Here, when the water collection tray 40 is inserted into the main body 10, part of the water collection tray is exposed from the main body 10. That is, as shown in FIGS. 2 and 3, part of the water collection tray 40 is exposed to a right side of the drawing, that is, a front of the main body 10 in which the heating space 13 is open.

The reason is because such a structure allows water guided by the guide part 50 of the front door 90, which will be described later with reference to FIG. 3, to be collected through the exposed part of the water collection tray 40.

Further, an accommodation recess 15 having a predetermined depth inward is formed in the main body 10 to allow the water collection tray 40 to be accommodated in the main body 10. A receiving recess 60 is formed in a surface of the front door 90 corresponding to the accommodation recess 15 to accommodate part of the water collection tray 40 exposed from the main body 10.

Here, the accommodation recess 15 and the receiving recess 60 are formed to have a corresponding length. The length may be at least equal to or larger than the length of the water collection tray 40.

In addition, as shown in FIGS. 2 and 5, when the front door 90 is open, the receiving recess 60 provides a space for withdrawing the water collection tray 40, thus allowing the water collection tray to be easily withdrawn.

As shown in FIG. 4, the water collection tray 40 includes a water collection container 41 that has a predetermined length, with a space defined to collect water therein, a top cover 43 that closes an open top of the water collection container 41, and a water inlet hole 45 that is formed through the top cover 43 at a center in a longitudinal direction of the top cover 43 that is exposed from the main body 10, water guided through the guide part 50 of the front door 90 being introduced into the water inlet hole.

Preferably, the water inlet hole 45 is formed at a center in a longitudinal direction of an inclined groove 47 such that the water inlet hole is formed under a surface of the top cover 43. The inclined groove is formed in part of the top cover 43 that is exposed from the main body 10 to be depressed, and is gradually inclined downwards from each of opposite sides in the longitudinal direction of the top cover 43 to a center thereof.

The reason why the water inlet hole 45 is formed at the center of the inclined groove 47 is as follows: water flowing down from the main body 10 to the partially exposed water collection tray 40 is guided along the inclined groove 47 into the water inlet hole 45.

Further, the inclined groove 47 allows the water collection tray 40 to be easily held and withdrawn when the water collection tray 40 is separated from the main body 10.

Since the top cover 43 closes the open top of the water collection container 41, it prevents water collected in the water collection tray 40 from overflowing when the water collection tray is separated from the heating cabinet or is moved to empty the water.

The front door 90 is rotatably coupled to a side of the main body 10 via a shaft, thus selectively closing the open heating space 13 and simultaneously receiving the water collection tray 40 that is partially exposed from the main body 10. Further, the guide part 50 is formed in a surface of the front door 90 facing the heating space 13 to guide water, produced when the object T is heated, into the water collection tray 40.

The guide part 50 of the front door 90 includes a depressed surface 53 that is formed in the surface facing the heating space 13 to be depressed at a predetermined depth, an inclined edge 57 that is formed at a predetermined angle from each of opposite ends of a lower portion of the depressed surface 53 to the water collection tray 40 such that the water produced in the depressed surface 53 when the object T is heated in the state where the front door 90 closes the heating space 13 is guided into the water collection tray 40, and a water collection path 59 that is formed at an end of the inclined edge 57 and is connected with the depressed surface 53 such that guided water flows towards the water collection tray 40.

Of course, a surface forming the depressed surface 53 is formed to be smooth to allow water to flow down in the direction of gravity.

In addition, as shown in FIG. 3, as the water collection path 59 is located above the water inlet hole 45 of the water collection tray 40 in the state where the front door 90 is closed, water guided by the depressed surface 53 and the inclined edge 57 is dropped to the water inlet hole 45.

Although it has been described herein that water is collected into the water collection tray 40 through the structure of the guide part 50, a plurality of paths may be formed in the front door 90 to collect the water without being limited to the above-mentioned structure.

Preferably, a gasket 70 is provided in the surface of the front door 90 facing the heating space 13 to protrude from the surface while surrounding the depressed surface 53. Further, a contact protrusion 17 is formed on the main body 10 to protrude therefrom and is in contact with the gasket 70 while surrounding the open heating space 13.

When the front door 90 is closed, the gasket 70 and the contact protrusion 17 come into close contact with each other, thus completely sealing the heating space 13 from the outside. The gasket 70 may be made of synthetic resin having elasticity.

Further, a handle 80 is formed on a peripheral surface of an upper portion of the front door 90 to open or close the front door 90. However, a location of the handle 80 is not limited.

Hereinafter, a process of collecting water in the water collection tray 40 when the heating cabinet 100 according to the present invention is driven will be described with reference to the accompanying drawings.

First, the front door 90 is opened, the wet towel T is put into the heating space 13, the front door 90 is closed, and power is applied to the heating cabinet to drive the heating device installed in the heating cabinet 100.

Here, a heating temperature of the heating cabinet 100 is set by a separate control unit (not shown).

As the heating device is driven, the temperature of the heating space 13 slowly rises. At this time, water (water vapor) is produced from the wet towel T.

The produced water forms water droplets throughout the depressed surface 53 of the front door 90. The water droplets formed in this way flow down along the depressed surface 53 in the direction of the gravity.

These water droplets are guided towards the water collection path 59 by the inclined edges 57 formed on the opposite sides of the depressed surface 53.

The water droplets flowing towards the water collection path 59 as such are dropped into the water inlet hole 45 formed in the top cover 43 as shown by the arrow of FIG. 3 while being collected in the water collection container 41.

That is, all the water droplets formed throughout the depressed surface 53 are guided by the inclined edges 57, pass through the water collection path 59, and then are dropped into the water collection tray 40.

Subsequently, if the heating cabinet is used for a lengthy period of time and thus the water collection tray 40 is filled with water, a user holds the inclined groove 47 of the top cover 43 and pulls the water collection tray 40 out from the receiving recess 60 of the front door 90 in a direction shown by a one-dot chain line of FIG. 5. In this state, the water collection tray 40 is raised to be separated from the heating cabinet 100 and then is moved to empty the water.

At this time, since the water collection container 41 is closed by the top cover 43, water is prevented from overflowing when the water collection tray 40 is moved to empty the water.

A process of coupling the water collection tray 40 to the heating cabinet 100 is performed in reverse order of the withdrawing process.

As described above, the present invention provides a heating cabinet, in which a water collection tray for collecting water is located in the heating cabinet such that the tray is not exposed to the outside, thus improving a front structure of the heating cabinet, and water produced when an object is heated is collected in the water collection tray, thus keeping an interior of the heating cabinet closed, and a top of the water collection tray is closed, thus preventing water collected therein from overflowing when the water collection tray is separated or moved from the heating cabinet.

What is claimed is:

1. A heating cabinet comprising:
a main body defining a heating space in which an object to be heated is seated;
a water collection tray provided under the heating space to be accommodated in the main body, and collecting water produced when the object is heated; and
a front door rotatably coupled to a side of the main body to selectively close the open heating space while receiving the water collection tray, the front door having a guide part that is formed on a surface facing the heating space to guide the water, produced when the object is heated, to the water collection tray,
wherein the water collection tray is inserted into the main body such that part of the water collection tray is exposed from the main body,
an accommodation recess with a predetermined depth is defined in the main body to allow the water collection tray to be accommodated in the main body, and
a receiving recess is defined in a surface of the front door corresponding to the accommodation recess to receive the part of the water collection tray that is exposed from the main body.

2. The heating cabinet as set forth in claim 1, wherein the water collection tray comprises:
a water collection container having a predetermined length, with a space defined to collect water therein;
a top cover closing an open top of the water collection container; and
a water inlet hole formed through the top cover at a center in a longitudinal direction of the top cover that is exposed from the main body, water guided through the guide part of the front door being introduced into the water inlet hole.

3. The heating cabinet as set forth in claim 2, wherein the water inlet hole is formed at a center in a longitudinal direction of an inclined groove such that the water inlet hole is formed under a surface of the top cover, the inclined groove being formed in part of the top cover that is exposed from the main body to be depressed and being gradually inclined downwards from each of opposite sides in the longitudinal direction of the top cover to a center thereof.

4. The heating cabinet as set forth in claim 3, wherein the guide part of the front door comprises:
a depressed surface formed on the surface facing the heating space to be depressed at a predetermined depth;
an inclined edge formed at a predetermined angle from each of opposite ends of a lower portion of the depressed surface to the water collection tray such that the water produced in the depressed surface when the object is heated in a state where the front door closes the heating space is guided into the water collection tray; and
a water collection path formed at an end of the inclined edge and connected with the depressed surface such that guided water flows towards the water collection tray.
